(19) United States
(12) Patent Application Publication
(10) Pub. No.: US 2013/0152438 A1
(43) Pub. Date: Jun. 20, 2013

(54) STRETCHABLE MESSAGE DELIVERY SYSTEM

(71) Applicant: Joel Morris, Savannah, GA (US)

(72) Inventor: Joel Morris, Savannah, GA (US)

(21) Appl. No.: 13/525,807

(22) Filed: Jun. 18, 2012

Related U.S. Application Data
(63) Continuation-in-part of application No. 13/024,816, filed on Feb. 10, 2011, now abandoned.

(51) Int. Cl. G09F 3/02

(52) U.S. Cl. CPC G09F 3/02
USPC 40/625; 101/35

(57) ABSTRACT

A method for promoting individual support, affiliation or allegiance, including printing a message on an elastic loop, wherein the message is decompressed and fully legible when the elastic loop is stretched and wherein the message is compressed and not fully legible when the elastic loop is unstretched, and distributing the elastic loop to a wearer. The elastic loop is sized to be stretched when worn on the wearer's wrist, such that the message is expanded into an uncompressed and legible configuration.

### CROSS-REFERENCE TO RELATED APPLICATIONS

This patent application is a continuation-in-part of co-pending U.S. patent application Ser. No. 13/024,816, filed on Feb. 10, 2011, and claims priority thereto.

### TECHNICAL FIELD

The novel technology relates generally to the field of apparel and, more particularly, to elastic bracelets.

### BACKGROUND

Recently, plastic or rubber wristwear has become popular with children, teenagers, and adults alike. On one end of the spectrum are rubber bands that when relaxed, take the shape of outlines or silhouettes of characters, animals, vehicles, and objects of interest. These items tend to be brightly colored, and favored by younger wearers. On the other end are plastic bands of specific colors and/or insignia for displaying support for or allegiance to a cause. These bracelets tend to be more somber and serious in tone and are favored by older wearers.

Currently, there are no bracelets that combine the fun aspects of the youthful rubber bands with the signification of support and allegiance promoted by the plastic bracelets. The present novel technology addresses this void.

### SUMMARY

The present invention relates to a system and method for promoting and signifying support and allegiance via an elastic wristband that legibly displays an image and/or message only when in a stretched state, such as when worn on a wrist. One object of the present invention is to provide an improved article of elastic jewelry. Related objects and advantages of the present invention will be apparent from the following description.

### BRIEF DESCRIPTION OF THE DRAWINGS

FIG. 1A is a first perspective view of a message display device in a relaxed state according to a first embodiment of the present novel technology.

FIG. 1B is a second perspective view of the message display device of FIG. 1A in a stretched state.

FIG. 2A is a first perspective view of an alternate message display device in a relaxed state according to a first embodiment of the present novel technology.

FIG. 2B is a second perspective view of the alternate message display device of FIG. 2A in a stretched state.

FIG. 3A is a first perspective view of a second alternate message display device according to the first embodiment of the present novel technology.

FIG. 3B is a second perspective view of the second alternate message display device according to the first embodiment of the present novel technology as worn on the wrist of a wearer.

FIG. 4A is a schematic view of a first unstretched message display device of FIG. 1 prior to addition of a message.

FIG. 4B is a schematic view of the device of FIG. 4A prior to selective stretching around a rigid member.

FIG. 4C is a schematic view of the device of FIG. 4B with a first portion partially stretched and a second portion more completely stretched.

FIG. 4D is a schematic view of the device of FIG. 4C with a first message portion positioned on the first portion and a second message portion positioned on the second portion.

FIG. 4E is a schematic view of the device of FIG. 4E in a relaxed, unstretched state.

FIG. 4F is a sechmatic view of the device of FIG. 4E in a uniformly stretched state.

### DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

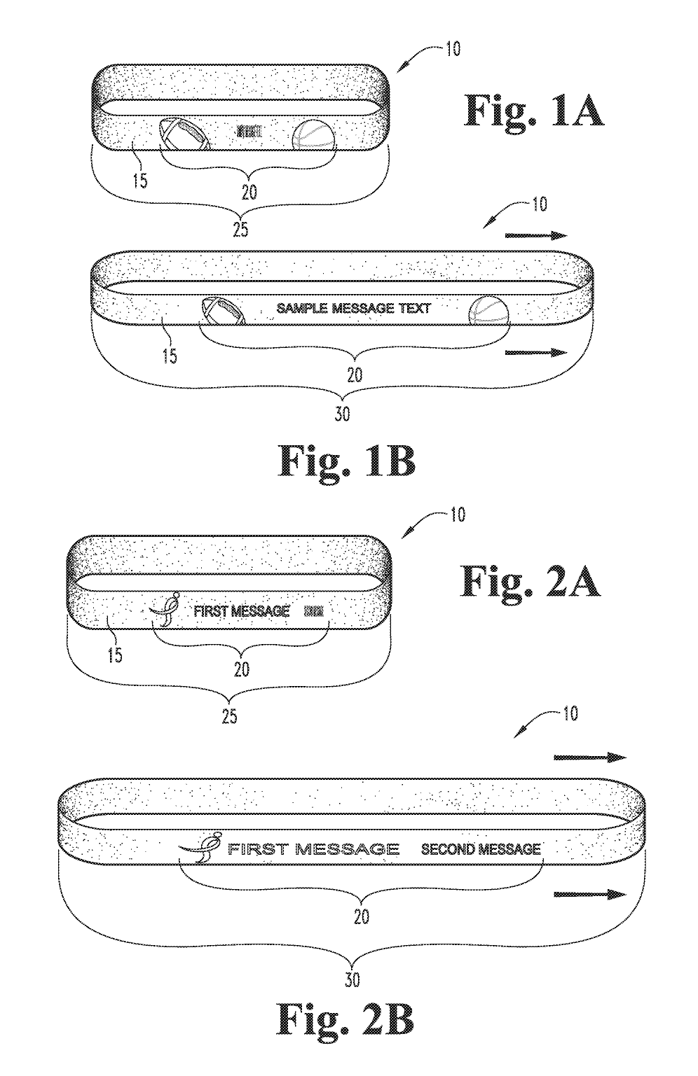

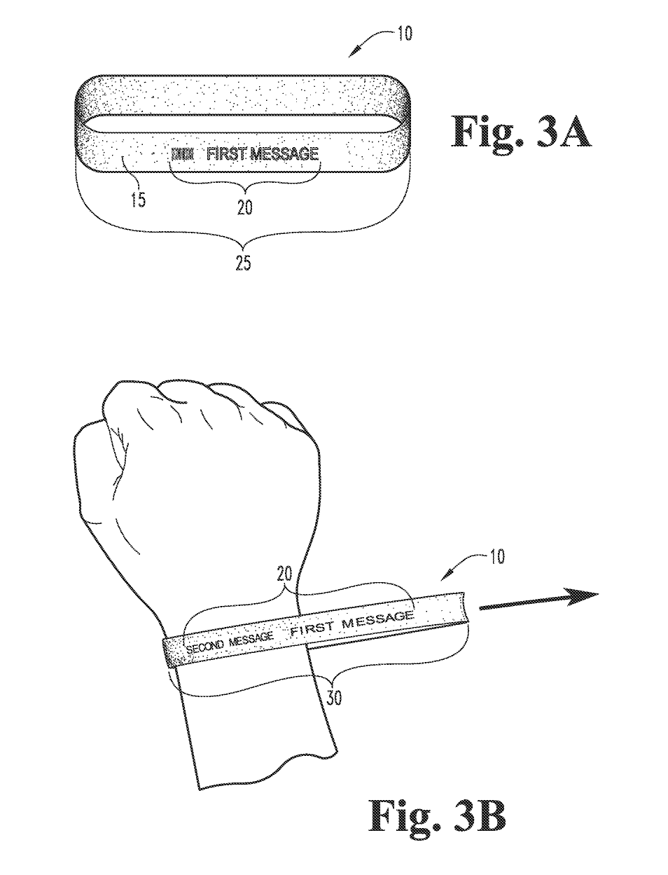

As illustrated in FIGS. 1A-3B, a first embodiment of the present novel technology relates to a wearable and stretchable message delivery system 10 for promoting support for and/or affiliation to a cause, team, activity or the like. The system 10 includes an endless, generally flat elastic portion 15 and a printed message portion 20 disposed on the elastic portion 15. The endless elastic portion 15 is typically composed of silicone rubber or the like, and has a first relaxed or unstretched state 25 and a second tensioned or stretched state 30. The message portion 20 is configured to be compressed and only partially legible when the elastic portion 15 is in its first relaxed state 25 and uncompressed and generally fully legible or viewable when the elastic portion 15 is in its stretched state 30.

The elastic portion 15 is typically formed as a band and is more typically sized to be smaller than a wearer's wrist in its relaxed state 25 and about the same size as a wearer's wrist when in its stretched state 30. Thus, the message portion 20 is uncompressed and legible when the system 10 is stretched to occupy its tensioned state 30 and positioned on a wearer's wrist.

Typically, the message portion 20 is applied to the elastic loop portion 15 when the elastic portion 15 is manually stretched. The elastic loop 15 is typically stretched non-uniformly, with a first portion 40 of the elastic loop 15 more stretched than a second portion 45 of the elastic loop 15. This allows the message 20 to be applied in two portions 50, 55, with a first message portion 50 appearing more compressed when the elastic loop 15 is relaxed and a second message portion 55 appearing less compressed with the loop 15 is relaxed. Consequently, when the loop 15 is uniformly stretched, the first message portion 50 appears less expanded than the second message portion 55, yielding the desired effect.

For example, a profile of Pinocchio may be printed on the first message portion 50 with his nose on the second message portion 55, so that when the elastic portion 15 is stretched and worn, the nose grows while the profile remains more or less the same.

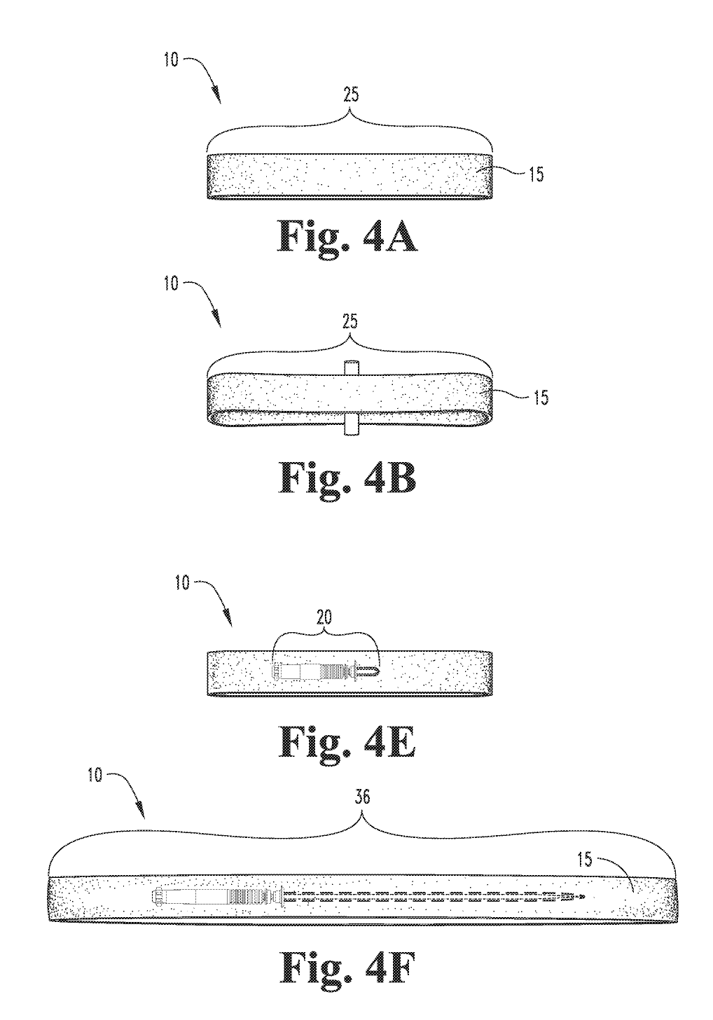

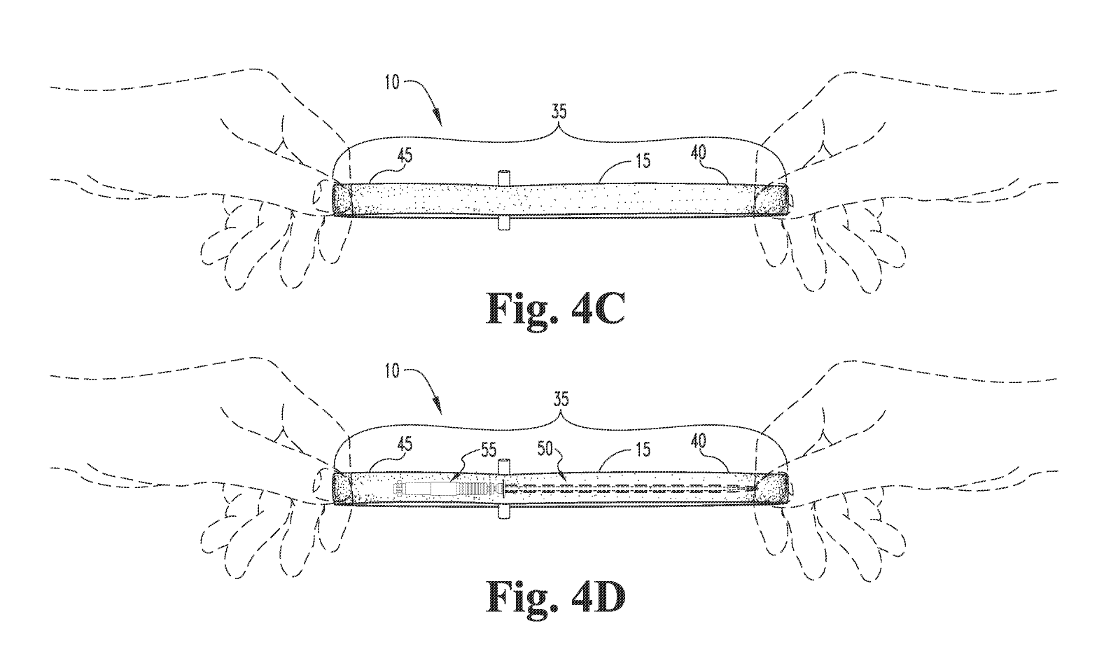

In operation, the system 10 functions as follows. The system 10 supports a method for promoting individual support, affiliation or allegiance. A message 20 is printed on an elastic loop 15, wherein the message 20 is decompressed and fully legible when the elastic loop 15 is stretched 30 and wherein the message 20 is compressed and not fully legible when the elastic loop is unstretched 25. The elastic loop 15 is distributed to a wearer. The elastic loop 15 is sized to be stretched 30 when worn on the wearer's wrist, such that the wearer's affiliation or allegiance to a cause, team, activity, sport, product or the like is readily displayed. The elastic loop 15 may be further stretched 30 by the wearer or others to more prominently display the message (see FIG. 3B).

In some embodiments, the message portion 20 is composed of text, in other embodiments the message portion 20 is composed of graphics, and in still other embodiments, the message portion 20 is made up of a combination of text and graphic elements. The message portion 20 may be configured to display a first image or message when relaxed and a second, different image or massage when stretched. Likewise, the message portion 20 may take on the appearance of a three dimensional image when stretched and viewed with appropriate viewing aids.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. An ornamental bracelet for use as an article of jewelry, comprising:
an elastic band sized and shaped to be worn around the wrist of a wearer and defining an inner surface and an outer surface; and
a printed image having a first image portion and a second image portion disposed on the outer surface;
wherein the elastic band has a first unstretched state and a second stretched state;
wherein the printed image is configured to be compressed when the elastic band is in the first unstretched state;
wherein the printed image is configured to be uncompressed when the elastic band is in the second stretched state; and
wherein the first image portion expands substantially more than the second image portion when the elastic band is in the second stretched state.

2. The bracelet of claim 1 wherein the printed image is a text message.

3. The bracelet of claim 1 wherein the printed image is a graphic image.

4. The bracelet of claim 1 wherein the printed image is a combination of text and graphic components.

5. An elastic wrist-mounted messaging system, comprising:
a generally flat loop of elastic material defining a message display surface having a first relaxed circumference and a second extended circumference; and
a message printed on the message display surface;
wherein the message includes a first message portion that is fully legible when the message display surface has the first relaxed circumference and a second message portion that is illegible when the message display surface has the first relaxed circumference; and
wherein the first message portion elongates slightly when the message portion has the second extended circumference and the second message portion elongates greatly when the message portion has the second extended circumference.

6. The messaging system of claim 5 wherein the message is a text message.

7. The messaging system of claim 5 wherein the message is a graphic image.

8. The messaging system of claim 5 wherein the message is a combination of text and graphic elements.

9. A method for promoting individual support, affiliation or allegiance, comprising:
a) stretching a first loop portion and a second loop portion of an elastic loop, wherein the first portion is stretched more than the second portion;
b) printing a first image portion on the stretched first loop portion;
c) printing a second image portion on the stretched second loop portion;
d) relaxing the elastic loop to compress first and second image portions; and
e) distributing the elastic loop to a wearer;
wherein the first and second loop portions are equally stretched when the elastic loop is stretched around a wearer's wrist;
wherein the first and second image portions are at least partially decompressed when the elastic loop is stretched around a wearer's wrist; and
wherein the second image portion elongates more than does the first image portion when the elastic loop is stretched around a wearer's wrist.
